(19) United States
(12) Patent Application Publication
(10) Pub. No.: US 2024/0291394 A1
(43) Pub. Date: Aug. 29, 2024

(54) USING BATTERY CHARGER AS A HEATER

(71) Applicant: Apple Inc., Cupertino, CA (US)

(72) Inventors: Ashish K Sahoo, Santa Clara, CA (US); Brandon Pierquet, San Francisco, CA (US); Jie Lu, San Jose, CA (US); Anish Prasai, Santa Clara, CA (US)

(21) Appl. No.: 18/175,864

(22) Filed: Feb. 28, 2023

(51) Int. Cl. H02M 7/219; H02M 1/08

(52) U.S. Cl. CPC H02M 7/219; H02M 1/08; H02J 2207/20

(57) ABSTRACT

Operating a battery charger having an AC side stacked half bridge configuration coupled to a primary winding of a transformer and a DC side stacked half bridge configuration coupled to a secondary winding of the transformer to provide heating can include either operating the AC side stacked half bridges to provide a current path through the primary winding that does not include an AC source or operating the DC side stacked half bridges to provide a current path through the secondary winding that does not include a battery. In the former case, operation can include operating the DC side stacked half bridges to alternate between switching states that selectively couple a battery to the secondary winding of the transformer. In the latter case, operation can include operating the AC side stacked half bridges to alternate between switching states that selectively couple the AC source to the primary winding.

### BACKGROUND

Battery powered systems are ubiquitous and range from lower power/small battery systems such as personal electronic devices to higher power/larger battery systems such as electrified vehicles, grid storage, etc. For each of these applications, improved charger operation and efficiency are desired while reducing cost and complexity. In some applications, it may be desirable to provide heat to regulate a temperature of an associated battery system or other systems.

### SUMMARY

This disclosure relates to improved battery charging systems that can operate the charger as a heater to provide heat to regulate a temperature of a battery system or other systems. For example, some applications may locate batteries and/or associated systems in environments having temperatures below what is considered optimal or even acceptable for such operation. Non-limiting examples could include vehicular batteries or grid storage batteries in cold climates. In such conditions, operation may be improved by heating such systems (e.g., heating coolant associated with the batteries) to keep the battery and/or associated systems in a more optimal temperature range.

A battery charger can include an AC side stacked half bridge converter having an input adapted to be coupled to an AC source and an output comprising a first switch node of a first upper half bridge and a second switch node of a first lower half bridge coupled to a primary winding of a transformer; a DC side stacked half bridge converter having an output selectively couplable to a battery by one or more contactors and an input comprising a third switch node of a second upper half bridge and a fourth switch node of a second lower half bridge coupled to a secondary winding of the transformer; and control circuitry that receives one or more sensed inputs and generates drive signals for switching devices of the respective half bridges. The control signals can operate the battery charger in a heating mode that does not deliver charging current to or draw discharging current from the battery by: closing one switch of the second upper half bridge and one switch of the second lower half bridge to provide a current path through the secondary winding of the transformer that does not include the battery; and alternating between: a first switching state in which a high side switch of the first upper half bridge and a low side switch of the first lower half bridge are closed and a low side switch of the first upper half bridge and a high side switch of the first lower half bridge are open; and a second switching state in which the high side switch of the first upper half bridge and the low side switch of the first lower half bridge are open and the low side switch of the first upper half bridge and the high side switch of the first lower half bridge are closed.

Closing one switch of the second upper half bridge and one switch of the second lower half bridge to provide a current path through the secondary winding of the transformer that does not include the battery can include closing a low side switch of the second upper half bridge and a high side switch of the second lower half bridge. Closing one switch of the second upper half bridge and one switch of the second lower half bridge to provide a current path through the secondary winding of the transformer that does not include the battery can include closing a low side switch of the second upper half bridge and a low side switch of the second lower half bridge. Closing one switch of the second upper half bridge and one switch of the second lower half bridge to provide a current path through the secondary winding of the transformer that does not include the battery can include closing a high side switch of the second upper half bridge and a high side switch of the second lower half bridge. Closing one switch of the second upper half bridge and one switch of the second lower half bridge to provide a current path through the secondary winding of the transformer that does not include the battery can include alternating between: closing a low side switch of the second upper half bridge and a low side switch of the second lower half bridge; and closing a high side switch of the second upper half bridge and a high side switch of the second lower half bridge.

The control circuitry can regulate a frequency of switching between the first switching state and the second switching state to control heat generated by the heating mode. At least one of the sensed inputs can be a temperature sensor, and the control circuitry can regulate the frequency of switching between the first switching state and the second switching state responsive to the temperature sensor. Closing one switch of the second upper half bridge and one switch of the second lower half bridge to provide a current path through the secondary winding of the transformer that does not include the battery and alternating between the first and second switching state can occur during off intervals of a burst mode charging operation.

A battery charger can include an AC side stacked half bridge converter having an input adapted to be coupled to an AC source and an output comprising a first switch node of a first upper half bridge and a second switch node of a first lower half bridge coupled to a primary winding of a transformer; a DC side stacked half bridge converter having an output selectively couplable to a battery by one or more contactors and an input comprising a third switch node of a second upper half bridge and a fourth switch node of a second lower half bridge coupled to a secondary winding of the transformer; and control circuitry that receives one or more sensed inputs and generates drive signals for switching devices of the respective half bridges, wherein the control signals operate the battery charger in a heating mode that does not deliver current to or draw current from the AC source by: closing a lower switch of the first upper half bridge and an upper switch of the first lower half bridge to provide a current path through the primary winding of the transformer that does not include the AC source; and alternating between first and second switching states of the second upper and second lower half bridges that selectively couple the battery to the secondary winding of the transformer.

In the first switching state, a high side switch of the second upper half bridge and a low side switch of the second lower half bridge can be closed, and a low side switch of the second upper half bridge and a high side switch of the second lower half bridge can be open; and in the second switching state, a high side switch of the second upper half bridge and a low side switch of the second lower half bridge can be open, and a low side switch of the second upper half bridge and a high side switch of the second lower half bridge can be closed.

In the first switching state, a low side switch of the second upper half bridge and a low side switch of the second lower half bridge can be closed, and a high side switch of the second upper half bridge and a high side switch of the second lower half bridge can be open; and in the second switching state, a high side switch of the second upper half bridge and a high side switch of the second lower half bridge can be closed, and a low side switch of the second upper half bridge and a low side switch of the second lower half bridge can be open.

The control circuitry can regulate a frequency of switching between the first switching state and the second switching state to control heat generated by the heating mode. At least one of the sensed inputs can be a temperature sensor, and the control circuitry can regulate the frequency of switching between the first switching state and the second switching state responsive to the temperature sensor. The control circuitry can regulate a duty cycle of switching between the first switching state and the second switching state to control heat generated by the heating mode. At least one of the sensed inputs can be a temperature sensor, and the control circuitry can regulate the duty cycle of switching between the first switching state and the second switching state responsive to the temperature sensor. The control circuitry can regulate a frequency and duty cycle of switching between the first switching state and the second switching state to control heat generated by the heating mode. At least one of the sensed inputs can be a temperature sensor, and the control circuitry can regulate the frequency and duty cycle of switching between the first switching state and the second switching state responsive to the temperature sensor.

A method of operating a battery charger, having an AC side stacked half bridge configuration including first upper and lower half bridges coupled to a primary winding of a transformer and a DC side stacked half bridge configuration including second upper and lower half bridges coupled to a secondary winding of the transformer, to provide heating can include operating either the first upper and lower half bridges to provide a first current path through the primary winding that does not include an AC source or the second upper and lower half bridges to provide a second current path through the secondary winding that does not include a battery. If operating the first upper and lower half bridges to provide a first current path through the primary winding that does not include an AC source, operation can include operating the second upper and lower half bridges to alternate between first and second switching states that selectively couple a battery to the secondary winding of the transformer. If operating the second upper and lower half bridges to provide a second current path through the secondary winding that does not include the battery, the operation can include operating the first upper and lower half bridges to alternate between first and second switching states that selectively couple the AC source to the primary winding of the transformer. The method can further include controlling a frequency of alternating between the first and second switching states to control heat generated. The method can further include controlling a duty cycle of the first and second switching states to control heat generated.

### BRIEF DESCRIPTION OF THE DRAWINGS

FIG. 1A illustrates a battery electrical system with a heater.

FIG. 1B illustrates a battery system charged from an AC source with a charger operated as a heater.

FIGS. 2A-2D illustrate a battery system charged from an AC source with a charger operated in a first mode as a heater.

FIG. 3A-3F illustrate a battery system charged from an AC source with a charger operated in a second or third mode as a heater.

FIG. 4A-4G illustrate a battery system charged from an AC source with a charger operated in a fourth or fifth mode as a heater.

FIGS. 5A-5B illustrate a battery system charged from an AC source with two chargers operated to provide charging/discharging and heating.

FIG. 6A-6B illustrate a battery system charged from an AC source with a charger operated in a burst mode as a heater.

FIGS. 7-9 illustrate a battery system charged from an AC source with two chargers operated to provide charging/discharging and heating.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

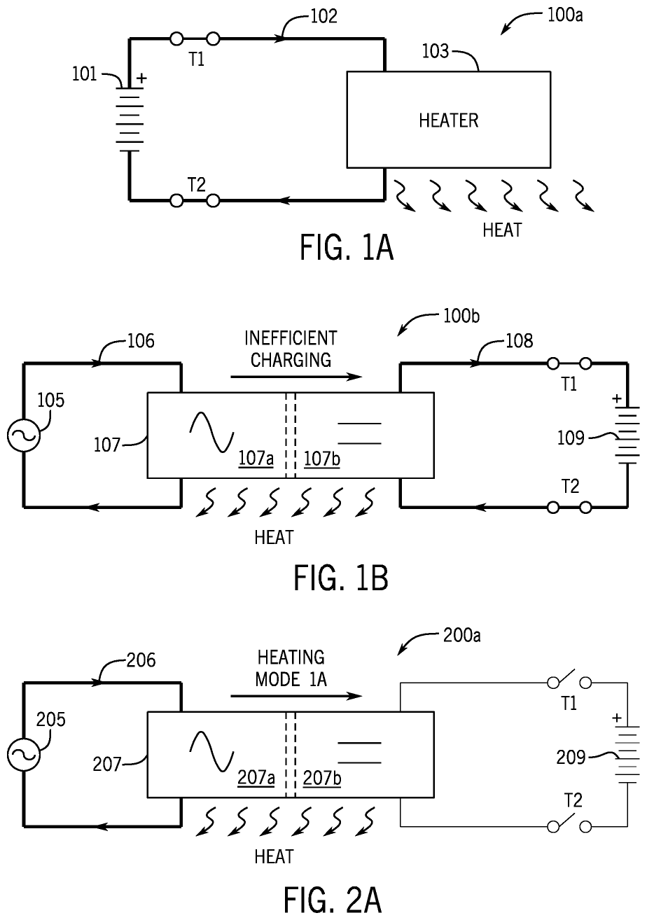

FIGS. 1A-1B illustrates battery electrical systems that provide heat. As described above, there are applications in which this is desirable. More specifically, FIG. 1A illustrates a battery powered system 100a in which a battery 101 is coupled via contactors T1/T2 to a heater 103. Battery 101 supplies a current 102 that drives heater 103 to produce heat. Heater 103 may take a variety of forms, such as a resistance heater, a heat pump, etc. Such systems are in common use, but typically require an extra element (i.e., heater) in addition to the other systems powered by battery 101 (not shown in FIG. 1A).

FIG. 1B addresses the “extra element” problem for battery powered system 100b in which a battery 109 is charged from an AC source 105. For example, battery 109 could be a traction battery in an electric vehicle, and AC source 105 could be AC mains. As another example, battery 109 could be a grid storage battery, and AC source 105 could again be AC mains. Numerous other examples are possible. In any case, AC source 105 supplies current 106 to a battery charger 107. Battery charger 107 in turn supplies charging current 108 to battery 109, which may be coupled to battery charger 107 by contactors T1/T2. Battery charger 107 may take a variety of forms. In the illustrated example, battery charger 107 can be switching converter that includes an AC side 107a and a DC side 107b as discussed in greater detail below. To solve the “extra element” problem described above, battery charger 107 may be operated in an “inefficient” manner, so that excess heat is generated by the charger itself, obviating the need for an additional heater (as in FIG. 1A). In general, such chargers/converters are operated as efficiently as possible to minimize wasted energy. However, all such systems operate with at least some inefficiency that produces excess heat. By varying the operation of the charger/converters, e.g., control of switching patterns, frequency, duty cycle, etc., battery charger 107 can be controlled to produce a desired degree of excess heat. To date such systems have relied on extensive look up tables for the programmable controller that operates the battery charger, requiring excessive amounts of memory and adding cost and complexity to the controller. Additionally, because such systems have relied on alteration of the battery charging operation, they have only been usable when AC source 105 is available and have required delivering at least some charging current to battery 109.

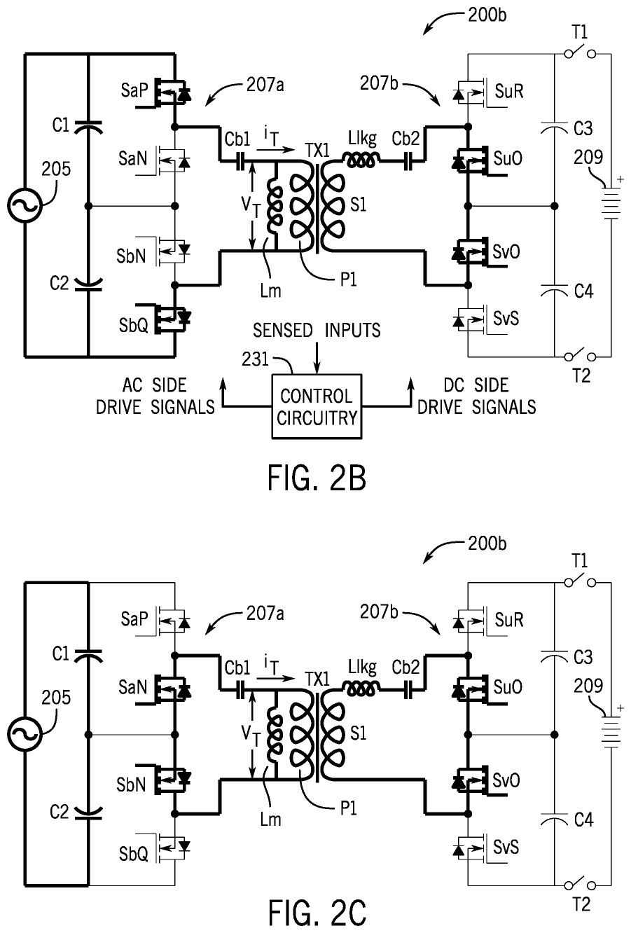

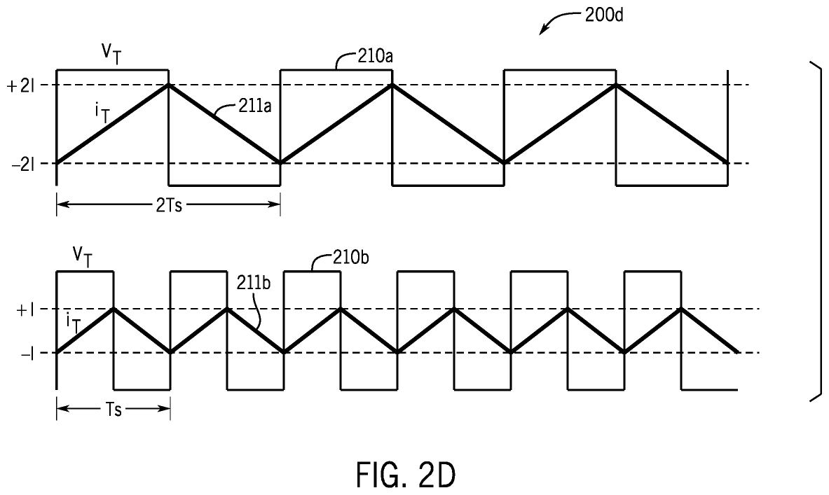

FIGS. 2A-2D illustrate a battery powered system 200a charged from an AC source with a charger operated in a first mode (Mode 1A) as a heater. In the first mode, the battery 209 can be disconnected from charger 207 by opening contactors T1/T2. Thus, this novel first mode can be employed without drawing current from or delivering current to battery 209. AC source 205 provides current 206 to battery charger 207, which is being operated as a heater. Battery charger 207 includes an AC side 207a and DC side 207b, discussed in greater detail below with respect to FIGS. 2B-2C, which illustrate alternate switching states of a first heating mode for operating battery charger 207 as a heater. More specifically, FIG. 2B illustrates a first switching state 200b of the first heating mode, and FIG. 2C illustrates a second switching state of the first heating mode.

With reference to FIG. 2B, a first switching state 200b of a first heating mode is illustrated. The depiction of battery charger 207 has been expanded to illustrate circuitry of the AC side 207a and the DC side 207b. This illustrated circuitry is only exemplary, and other circuit topologies could also be employed with the operating principles described herein. AC side 207a can incorporate a stacked half bridge converter, with an upper half bridge including switches SaP and SaN, and a lower half bridge including switches SbQ and SbN. Each respective half bridge may have a respective input capacitor C1/C2, and the half bridges may be coupled across the AC source 205. The output/switch node of the upper half bridge (i.e., the junction of switches SaP/SaN) may be coupled to one terminal of primary winding P1 of transformer T1 via a blocking capacitor Cb1. Similarly, the output/switch node of the lower half bridge (i.e., the junction of switches SbQ/SbN) may be coupled to the other terminal of primary winding P1 of transformer T1.

DC side 207b can also incorporate a stacked half bridge converter, including an upper half bridge including switches SuR and SuO and a lower half bridge including switches SvS and SvO. Each respective half bridge may have respective output capacitors C3/C4, and the half bridges may be coupled across battery 209. The input/switch node of the upper half bridge (i.e., the junction of switches SuR/SuO) may be coupled to one terminal of secondary winding S1 of transformer T1 via blocking capacitor Cb2. Similarly, the input/switch node of the lower half bridge (i.e., the junction of switches SvS/SvO) may be coupled to the other terminal of secondary winding S1 of transformer T1. Transformer T1 thus provides galvanic isolation between the AC side 207a and DC side 207b, as well as providing voltage/current multiplication depending on the turns ratio of the transformer. Also depicted in FIG. 2B is the magnetizing inductance Lm and leakage inductance Llkg of the transformer. These are not discrete physical components, but rather circuit representations of the magnetic properties of transformer T1. However, in some embodiments, it may be desirable to provide discrete inductors corresponding to these components to provide added inductance to achieve desired circuit operation in terms of energy storage, frequency characteristics, etc.

The switching devices described above and in the other embodiments and configurations described herein may be any suitable type of semiconductor switching device, including transistors such as metal oxide semiconductor field effect transistors (MOSFETs), insulated gate bipolar transistors (IGBTs), or other transistor types. Alternatively other semiconductor switching devices such as silicon controlled rectifiers (SCRs), thyristors, etc. could also be used. The semiconductor switching devices can be implemented using any suitable semiconductor technology, such as silicon, silicon carbide (SiC), gallium nitride (GaN), etc. Additionally, the topologies illustrated and discussed herein may be operated and controlled as bidirectional converters, allowing power delivery from the AC side to the DC side or vice versa, allowing for charge/discharge operations.

Also depicted in FIG. 2B is voltage v_{T} and current i_{T} applied to the primary winding of the transformer by AC side 207a. These are discussed in greater detail below. Another component illustrated in FIG. 2B is control circuitry 231. Control circuitry 231 can be implemented using any suitable combination of analog, digital, and/or programmable circuitry, such as operational amplifiers, comparators, logic gates, microcontrollers, microprocessors, etc. Control circuitry 231 can be configured to use such circuitry to implement control loops and/or control logic to operate the switching devices of charger 207 responsive to one or more sensed inputs. These sensed inputs can include relevant voltages, currents, temperatures; connection or disconnection of devices; etc. The implemented control loops and/or control logic can generate AC side drive signals to control switches SaP, SaN, SbQ, and SbN of the AC side 207a as well as DC side drive signals to control switches SuR, SuO, SvS, and SvO of the DC side 207b to achieve desired control of the circuitry, including controlled heat generation as described in greater detail below.

In the first switching state 200b of the first heating mode, switches SuO and SvO on DC side 207b can be closed, effectively short-circuiting secondary winding S1 of transformer T1. As illustrated, contactors T1 and T2 are opened, isolating battery 209, but this need not be the case. Also, in first switching state 200b, AC source 205 is coupled to primary winding by closing the high side switch SaP of the upper half bridge and the low side switch SbQ of the lower half bridge. This applies a voltage v_{T} and current i_{T} to transformer T1. FIG. 2C illustrates second switching state 200c of the first heating mode. In the second switching state, DC side 207b remains effectively short circuited by the closure of switches SuO/SvO. On AC side 207a, AC source 205 is effectively disconnected from transformer T1 by opening the high side switch SaP of the upper half bridge and the low side switch SbQ of the lower half bridge. Low side switch SaN of the upper half bridge and high side switch SbN of the lower half bridge are closed, effectively short-circuiting primary winding P1 of transformer T1. The first heating mode can thus be characterized by short circuiting the DC side using the “inner” switches of the stacked half bridge and alternating between first switching state 200b (in which the AC source is connected to the charger) and second switching state 200c (in which the AC source is decoupled from the charger). As a result, a resonant circuit made up of the blocking capacitors Cb1/Cb2 and the parasitic inductances of transformer T1 is driven at a frequency corresponding to the frequency of alternating between the two states.

Resultant waveforms 200d of such an operation are depicted in FIG. 2D, in which waveform 210a corresponds to voltage v_{T} at a first switching frequency corresponding to a switching period of 2Ts, and waveform 211a corresponds to current i_{T} at the first switching frequency. Waveform 210b corresponds to voltage v_{T} at a second (higher) switching frequency corresponding to a switching period of Ts, and waveform 211b corresponds to current i_{T} at the second (higher) switching frequency. As can be seen from the waveforms of FIG. 2D, the peak value of current i_{T} corresponds to 2I (4I peak-to-peak) in the lower frequency case and I (2I peak-to-peak) in the lower frequency case. Put another way, doubling the switching frequency halves the resultant current, or, more generally, increasing the switching frequency proportionally decreases the resultant current. Conduction losses associated with the system are proportional to the square of the current. Additionally, assuming ZVS operation, conduction losses can make up a substantial portion of the losses associated with charger 207 and thus the heat generated by the charger 207. Thus, control of the switching frequency between the first switching state 200a and second switching state 200b of the first heating mode can be used to control the amount of heat produced by the charger circuit, and more specifically by conduction losses associated with the charger circuit. Temperature sensing (e.g., by providing a temperature sensor input to control circuitry 331) can thus be used to achieve closed loop control of heating by varying the switching frequency.

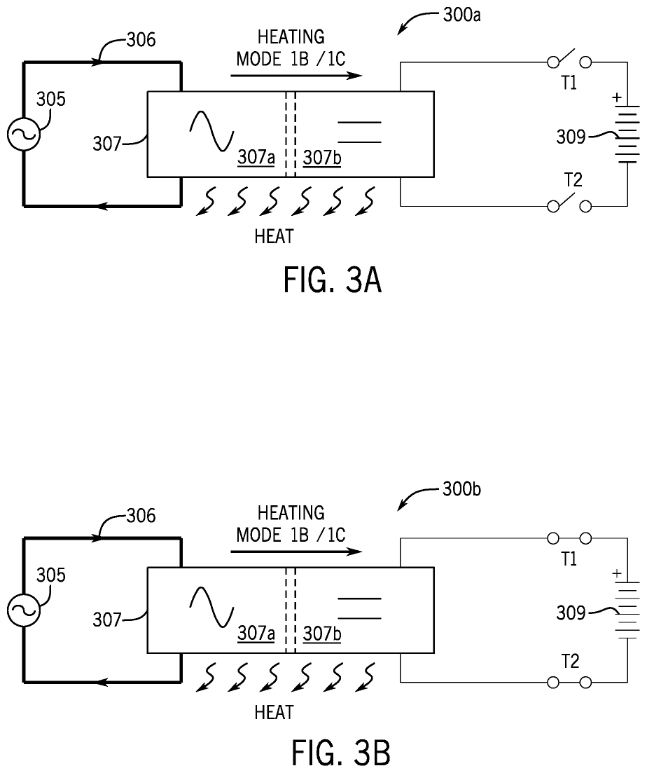

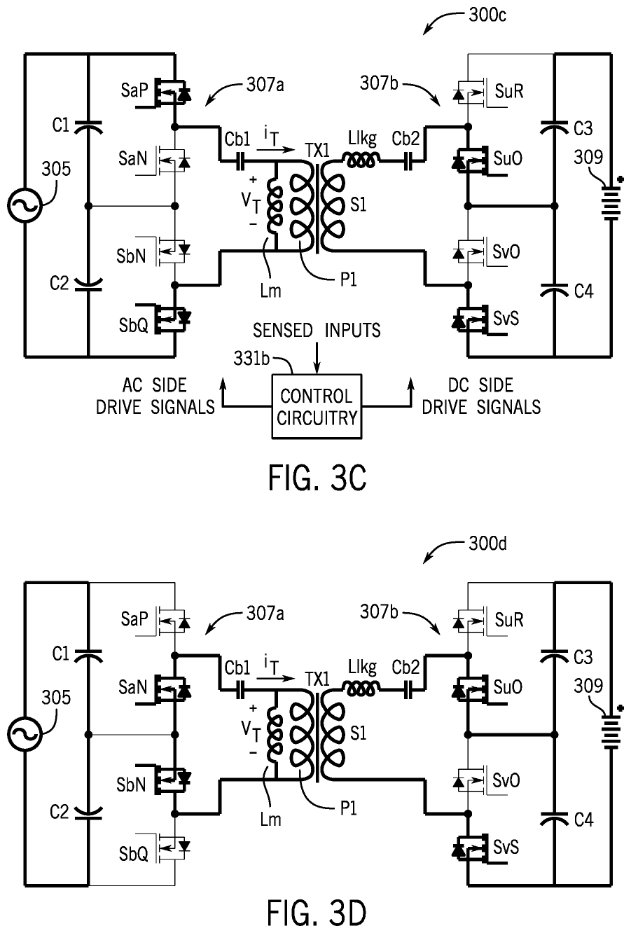

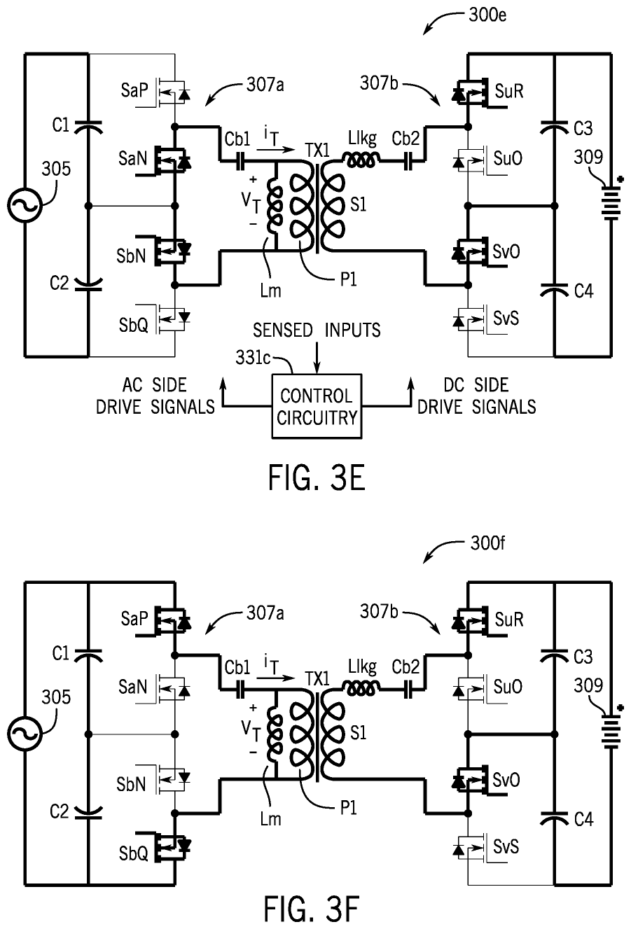

FIG. 3A-3F illustrate a battery system 300a charged from an AC source with a charger operated in a second or third mode (Modes 1B/1C) as a heater. Each of the second and third modes (described in greater detail below) can be used with the battery disconnected by contactors T1/T2, as illustrated in FIG. 3A, or with the battery connected by contactors T1/T2, as illustrated in FIG. 3B. Either way, neither the second or third mode results in a charging or discharging current to/from the battery. As illustrated in FIG. 3A, AC source 305 delivers current 306 to charger 307, which includes an AC side 307a and DC side 307b as described above. Operation of the second and third heating modes (Modes 1B/1C) can be used to produce heat as described in greater detail below, with no charging/discharging current to/from battery 309, which can be isolated by opening contactors T1/T2. As illustrated in FIG. 3B, AC source 305 delivers current 306 to charger 307, which includes an AC side 307a and DC side 307b as described above. Operation of the second and third heating modes (Modes 1B/1C) can be used to produce heat as described in greater detail below, with no net charging/discharging current to/from battery 309, which can be coupled to charger 307 by closing contactors T1/T2.

FIGS. 3C and 3D illustrate a second heating mode (Mode 1B), with a first switching state 300c depicted in FIG. 3C, and a second switching state 300d depicted in FIG. 3D. Circuit topology and construction of AC side 307a and DC side 307b can be as described above, and the circuit can be controlled by control circuitry 331b, which can also be constructed as described above. In both switching states of second heating mode 1B, the respective low side switches SuO and SvS of the DC side stacked half bridge are closed, and the respective high side switches SuR and SvO are opened. As compared to the first heating mode 1A described above, the difference on DC side 307b is that capacitor C4 of the lower half bridge is included in the secondary current path. On AC side 307a, operation can be as described above. Thus, “outer” switches SaP and SbQ of the respective half bridges can be turned on, and “inner” switches SaN and SbN can be turned off in first switching state 300c. Similarly, “outer” switches SaP and SbQ of the respective half bridges can be turned off, and “inner” switches SaN and SbN can be turned on in second switching state 300d. As described above, alternating between first switching state 300c and second switching state 300d at different frequencies changes the impedance, and thus the current, and thus the associated conduction losses. Control of the switching frequency between switching states 300c and 300d can thus be used to control heat generation as described above.

FIGS. 3E and 3F illustrate a third heating mode (Mode 1C), with a first switching state 300e depicted in FIG. 3E, and a second switching state 300f depicted in FIG. 3F. Circuit topology and construction of AC side 307a and DC side 307b can be as described above, and the circuit can be controlled by control circuitry 331c, which can also be constructed as described above. In both switching states of third heating mode 1C, the respective low side switches SuO and SvS of the DC side stacked half bridge are opened, and the respective high side switches SuR and SvO are closed. As compared to the first heating mode 1A described above, the difference on DC side 307b is that capacitor C3 of the lower half bridge is included in the secondary current path. On AC side 307a, operation can be as described above. Thus, “outer” switches SaP and SbQ of the respective half bridges can be turned on, and “inner” switches SaN and SbN can be turned off in first switching state 300e. Similarly, “outer” switches SaP and SbQ of the respective half bridges can be turned off, and “inner” switches SaN and SbN can be turned on in second switching state 300f. As described above, alternating between first switching state 300e and second switching state 300f at different frequencies changes the impedance, and thus the current, and thus the associated conduction losses. Control of the switching frequency between switching states 300e and 300f can thus be used to control heat generation as described above.

In some applications alternating between first, second, and third heating modes 1A, 1B, and 1C may be desirable. Each of these modes is characterized by a lack of charging/discharging current through the battery. Additionally, heating is evenly distributed among the AC side switches in each mode. However, each mode distributes heating differently among the DC side switches. More specifically, in the first mode (Mode 1A), inner switches SuO and SvO contribute to the conduction losses, while “outer” switches SuR and SvS do not. In the second mode (Mode 1B), “lower” switches SuO and SvS contribute to the conduction losses, while “upper” switches SuR and SvO do not. In the third mode, (Mode 1C), the situation is reversed and “lower” switches SuO and SvS do not contribute to the conduction losses, while “upper” switches SuR and SvO do. Thus, depending on physical configuration, packaging, switches used, etc., combinations of the respective modes can be used. For example, alternating between the second and third modes (Modes 1B/1C) can equalize the heating contribution from all switches on DC side 307b.

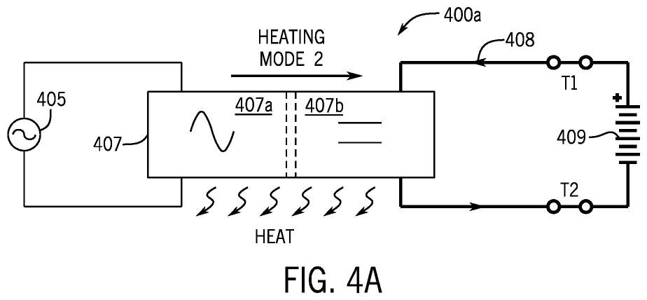

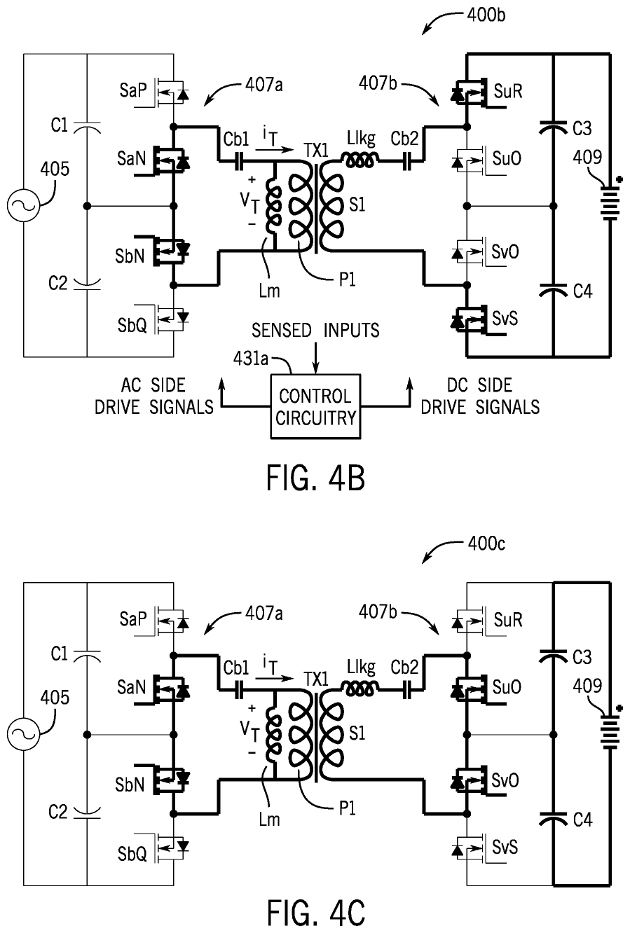

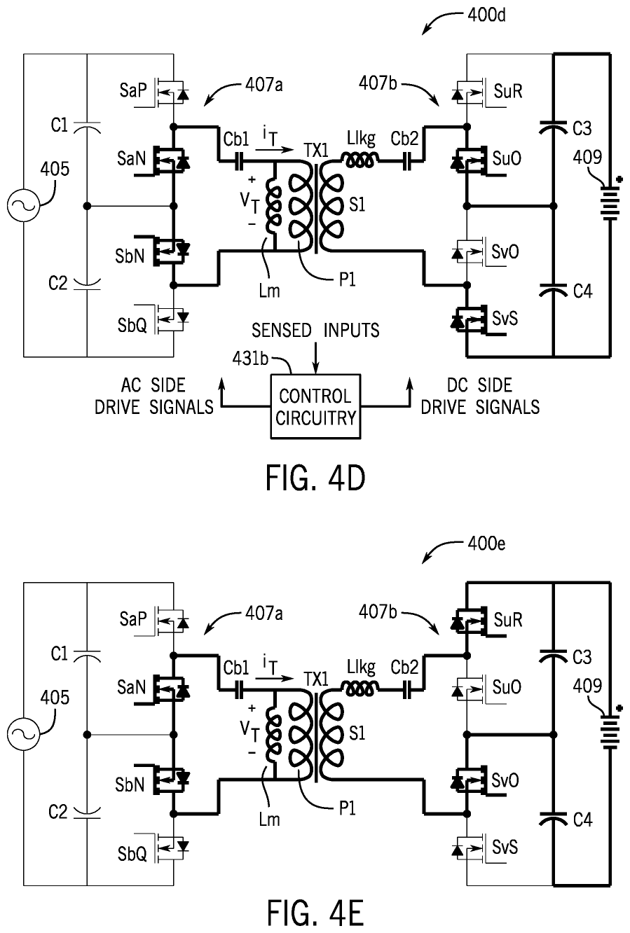

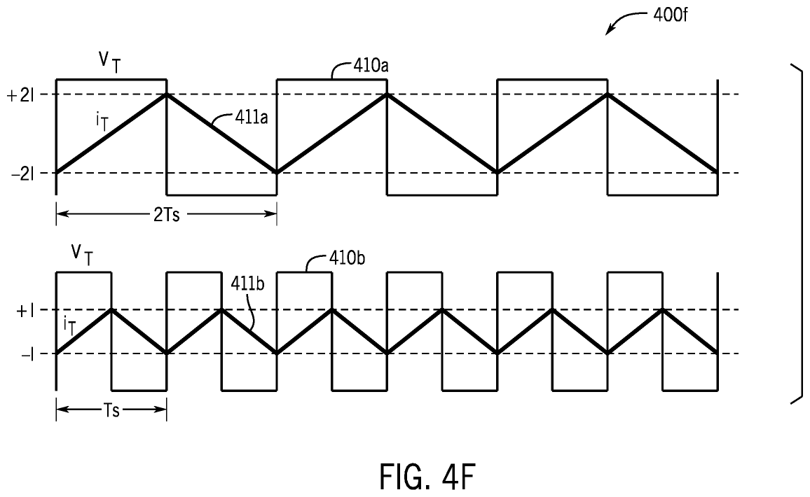

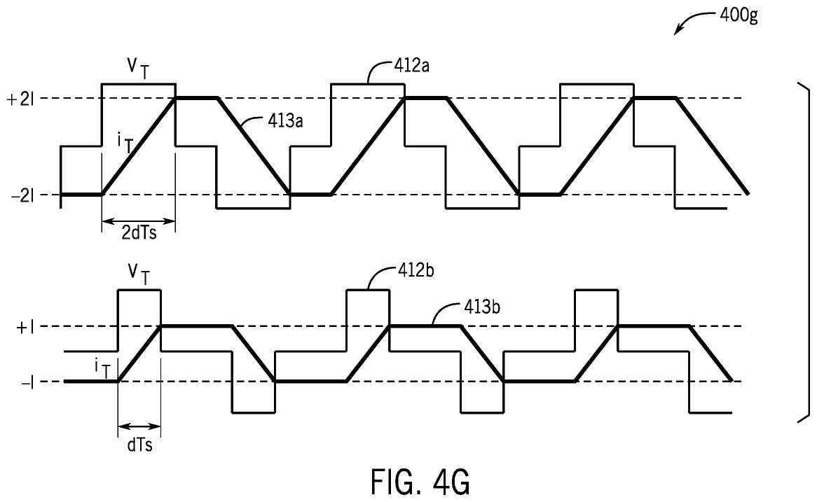

FIG. 4A-4G illustrate a battery system charged from an AC source with a charger operated in a fourth or fifth mode (Mode 2A/2B) as a heater. Each of the fourth and fifth modes (described in greater detail below) can be used with the AC disconnected, as illustrated in FIG. 4A. This necessitates drawing the current for heat generation from the battery. As illustrated in FIG. 4A, system 400a includes an AC source 405 does not deliver current to battery charger 407 (e.g., because the AC source is disconnected or otherwise unavailable. Operation of the fourth and fifth heating modes (Modes 2A/2B) can be used to produce heat as described in greater detail below. Operation of the fourth and fifth heating modes (Modes 2A/2B) can be used to produce heat as described in greater detail below using current 408 from battery 409, which can be coupled to charger 407 by closing contactors T1/T2.

FIGS. 4B and 4C illustrate a fourth heating mode (Mode 2A), with a first switching state 400b depicted in FIG. 4B, and a second switching state 400c depicted in FIG. 3C. Circuit topology and construction of AC side 407a and DC side 407b can be as described above, and the circuit can be controlled by control circuitry 431a, which can also be constructed as described above. In both switching states of fourth heating mode 22, the “inner” switches SaN and SbN of the AC side half bridges are closed, while the “outer” switches SaP and SbQ are open, effectively disconnecting AC source 405 (which need not be present at all). On the DC side 407b, in first switching state 400b, “outer” switches SuR and SvS are closed, while “inner” switches SuO and SvO are open. Conversely, in second switching state 400c, “outer” switches SuR and SvS are open, while “inner” switches SuO and SvO are closed. As described above, alternating between first switching state 400b and second switching state 400c at different frequencies changes the impedance, and thus the current, and thus the associated conduction losses. Control of the switching frequency between switching states 400b and 400c can thus be used to control heat generation as described above.

FIGS. 4D and 4E illustrate a fifth heating mode (Mode 2B), with a first switching state 400d depicted in FIG. 4D, and a second switching state 400e depicted in FIG. 4E. Circuit topology and construction of AC side 407a and DC side 407b can be as described above, and the circuit can be controlled by control circuitry 431b, which can also be constructed as described above. In both switching states of fifth heating mode 2B, the “inner” switches SaN and SbN of the AC side half bridges are closed, while the “outer” switches SaP and SbQ are open, effectively disconnecting AC source 405 (which need not be present at all). On the DC side 407b, in first switching state 400d, “lower” switches SuO and SvS are closed, while “upper” switches SuR and SvO are open. Conversely, in second switching state 400e, “upper” switches SuR and SvO are closed, while “lower” switches SuO and SvS are open. As described above, alternating between first switching state 400d and second switching state 400e at different frequencies changes the impedance, and thus the current, and thus the associated conduction losses. Control of the switching frequency between switching states 400e and 400f can thus be used to control heat generation as described above.

FIG. 4F illustrates resultant waveforms 400f of frequency-controlled operation as described above with respect to fourth and fifth modes 2A/2B, and generally corresponds to the waveforms discussed above with reference to FIG. 2D. More specifically, waveform 410a corresponds to voltage v_{T} at a first switching frequency corresponding to a switching period of 2Ts, and waveform 411a corresponds to current i_{T} at the first switching frequency. Waveform 410b corresponds to voltage v_{T} at a second (higher) switching frequency corresponding to a switching period of Ts, and waveform 411b corresponds to current i_{T} at the second (higher) switching frequency. As can be seen from the waveforms of FIG. 4F, the peak value of current i_{T} corresponds to 2I (4I peak-to-peak) in the lower frequency case and I (2I peak-to-peak) in the lower frequency case. Put another way, doubling the switching frequency halves the resultant current, or, more generally, increasing the switching frequency proportionally decreases the resultant current. Conduction losses associated with the system are proportional to the square of the current. Additionally, assuming ZVS operation, conduction losses can make up a substantial portion of the losses associated with charger 407 and thus the heat generated by the charger 407. Thus, control of the switching frequency between the first and second switching states of the respective fourth and fifth heating modes can be used to control the amount of heat produced by the charger circuit, and more specifically by conduction losses associated with the charger circuit. Temperature sensing (e.g., by providing a temperature sensor input to control circuitry 431a/b) can thus be used to achieve closed loop control of heating by varying the switching frequency.

In addition to or as an alternative to frequency control as described above, duty cycle control could be used to regulate heat production. FIG. 4G illustrates resultant waveforms 400g of duty-cycle-controlled operation, and generally corresponds to the waveforms discussed above with reference to FIG. 4F. More specifically, waveform 412a corresponds to voltage v_{T} at a first switching duty cycle corresponding to a duty cycle of 2dTs, and waveform 413a corresponds to current i_{T} at the first switching duty cycle. Waveform 412b corresponds to voltage v_{T} at a second (shorter) switching duty cycle dTs, and waveform 413b corresponds to current i_{T} at the second (shorter) switching duty cycle. As can be seen from the waveforms of FIG. 4F, the peak value of current i_{T} corresponds to 2I (4I peak-to-peak) in the longer duty cycle case and I (2I peak-to-peak) in the shorter duty cycle case. Put another way, increasing the switching duty cycle increases the resultant current. Conduction losses associated with the system are proportional to the square of the current. Additionally, assuming ZVS operation, conduction losses can make up a substantial portion of the losses associated with charger 407 and thus the heat generated by the charger 407. Thus, control of the duty cycle between the first and second switching states of the respective fourth and fifth heating modes can be used to control the amount of heat produced by the charger circuit, and more specifically by conduction losses associated with the charger circuit. Temperature sensing (e.g., by providing a temperature sensor input to control circuitry 431a/b) can thus be used to achieve closed loop control of heating by varying the switching frequency.

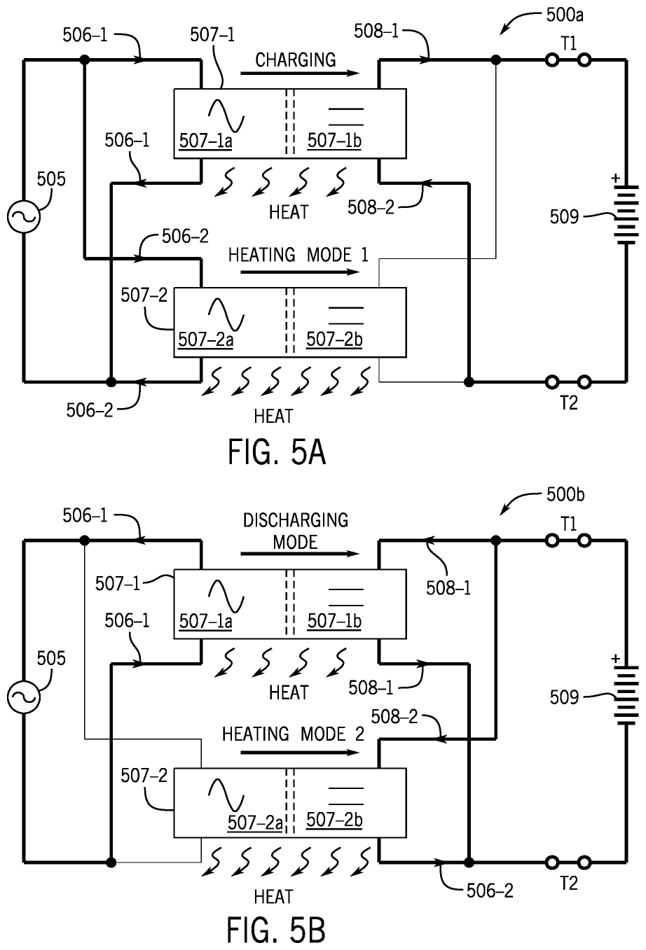

FIGS. 5A-5B illustrate a battery system charged from an AC source with two chargers operated to provide charging/discharging and heating. Such arrangements may be used in applications in which the charger is built from discrete modules. In the arrangements of FIGS. 5A-5B, two charger modules are shown, but any number of charger modules could be provided as appropriate for a given application. With reference to FIG. 5A, a system 500a illustrating two chargers 507-1 and 507-2 is illustrated. Each charger receives input power from AC source 505. AC source 505 delivers a first current 506-1 to charger 507-1 and a second current 506-2 to charger 507-2. Each charger includes respective AC sides 507-1a/507-2a and DC sides 507-1b/507-2b as described above. In the illustrated example, charger 507-1 can operate to deliver charging current 508-1 to battery 509, which can be coupled to the charger by closing contactors T1/T2. In some embodiments, charger 507-1 can be operated to provide auxiliary heat, although charger 507-1 could also be operated solely to provide charging functionality. Charger 507-2 can be operated as a heater, for example using one of the first, second, or third heating modes (1A/1B/1C) described above, which do not necessitate it delivering power to the battery. Thus, using a configuration like FIG. 5A, one charger (507-1) can use up to 100% of its total capacity to deliver charging current to the battery, while the other charger (507-2) can use up to 100% of its total capacity to deliver auxiliary heat. As described above, the heating of each module can be regulated, e.g., by thermostatic control, to provide the desired amount of heating. Such a configuration may be used, for example, in charging a vehicular traction battery or grid storage battery in a colder climate where extra heating is required to keep the battery in a desired operational temperature range.

With reference to FIG. 5B, a system 500b illustrating two chargers 507-1 and 507-2 is illustrated. Each charger is coupled to AC source 505; however, instead of receiving power from AC source 505, charger 507-1 can deliver current 506-1 to AC source, as might be used in a vehicle to grid (V2G) or grid battery energy recovery operation. As described above, each charger includes respective AC sides 507-1a/507-2a and DC sides 507-1b/507-2b as described above. In the illustrated example, charger 507-1 can operate to draw discharging current 508-1 from battery 509, which can be coupled to the charger by closing contactors T1/T2. In some embodiments, charger 507-1 can be operated to provide auxiliary heat, although charger 507-1 could also be operated solely to provide current 506-1 to the AC source 505 (e.g., AC grid). Charger 507-2 can be operated as a heater, for example using one of the fourth or fifth heating modes (2A/2B) described above, which do not necessitate it delivering power to the grid. Thus, using a configuration like FIG. 5B, one charger (507-1) can use up to 100% of its total capacity to deliver current to the grid, while the other charger (507-2) can use up to 100% of its total capacity to deliver auxiliary heat. As described above, the heating of each module can be regulated, e.g., by thermostatic control, to provide the desired amount of heating. Such a configuration may be used, for example, in grid support operations such as V2G or grid storage battery discharge.

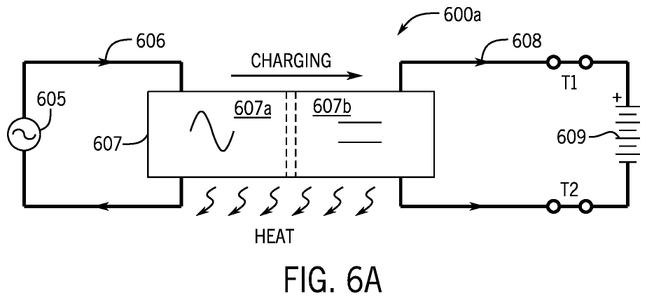

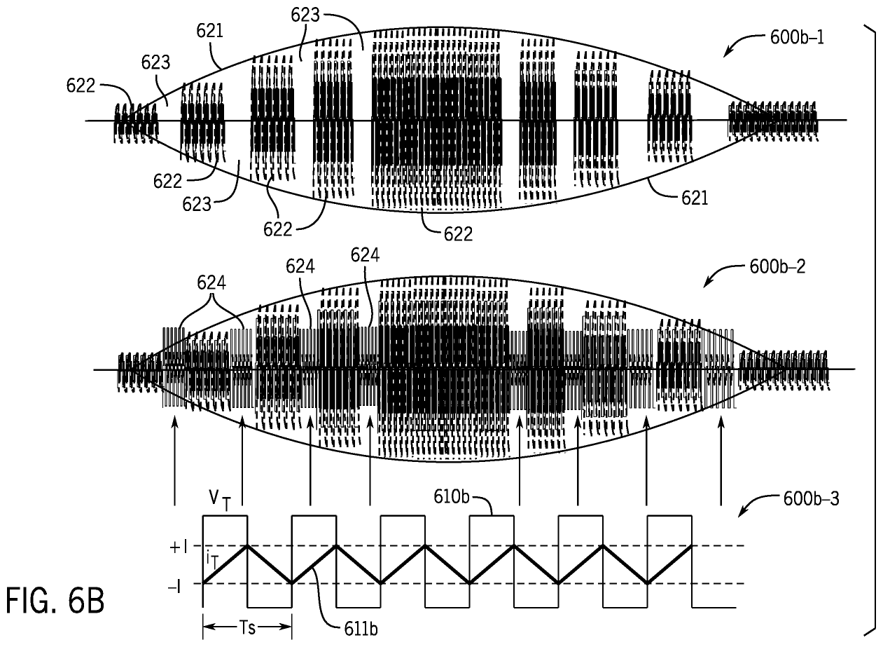

FIG. 6A-6B illustrate a battery system charged from an AC source with a charger operated in a burst mode as a heater. In some applications, burst mode operation may be used under low load conditions, e.g., when the battery is nearing full charge. As illustrated in FIG. 6A, system 600a includes an AC source 605 can deliver charging current 606 to charger 607, which can include AC side 607a and DC side 607b, as described above. Charger 607 can deliver charging current 608 to battery 609, which can be coupled via contactors T1/T2. In burst mode operation, switching of the switching devices of charger 607 is intermittently enabled and disabled as illustrated in FIG. 6B to allow for operation at an optimal frequency/duty cycle, to supply a relatively lower power requirement. FIG. 6B, plot 600b-1 illustrates an example of burst mode operation over one-half cycle of the input AC waveform. The input waveform envelope 621 corresponds to a half cycle of the input AC voltage from AC source 605. Switching devices of charger 607 are operated in switching intervals 622 and disabled during intervals 623. These are the “bursts” of switching during burst mode operation.

Waveform plot 600b-2 illustrates the use of the burst off intervals 624 to provide a heating function; for example using the second or third modes (1B/1C) discussed above. No power need be delivered to battery 609 during these intervals. In other words, during what would be the burst off intervals 623 associated with a burst mode charging cycle, the converter may be operated according to one of the first, second, or third heating modes described above to provide excess heating. Plot 600b-3 illustrates voltage v_{T} and current i_{T} corresponding to operation during the burst periods 624. Waveform 610b corresponds to voltage v_{T} at a switching frequency corresponding to a switching period of Ts, and waveform 611b corresponds to current i_{T} at the switching frequency. During the burst heating intervals 624, current can be controlled, for example by varying the switching frequency as described above to regulate heat delivery. By using one or more temperature sensors or other appropriate inputs, closed loop heating control can be achieved.

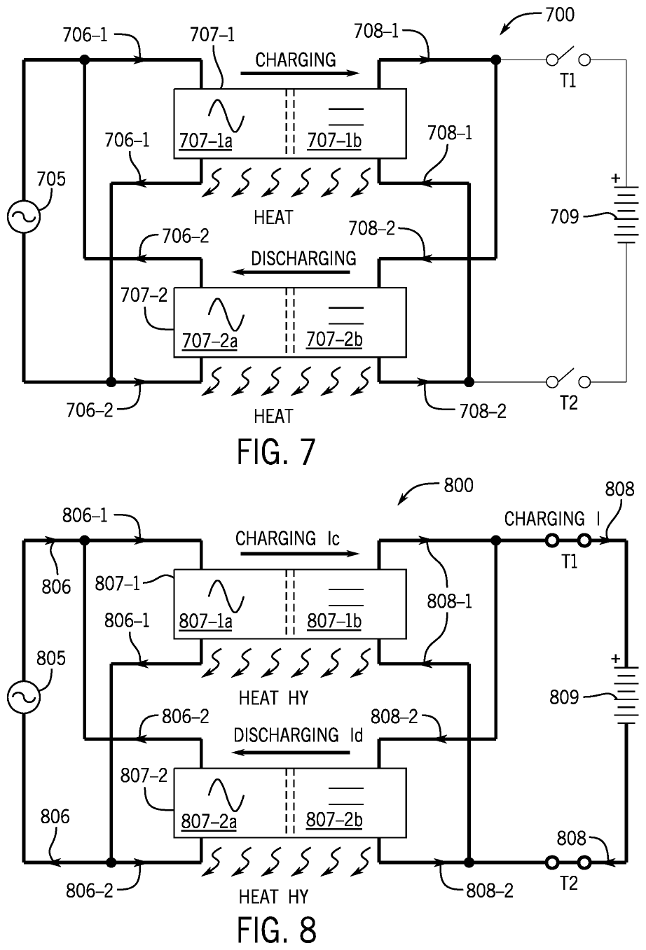

FIGS. 7-9 illustrate respective battery systems charged from an AC source with two chargers operated to provide charging/discharging and heating. As described above with reference to FIGS. 5A-5B, systems may be built employing multiple charger modules. Although the illustrated examples of FIGS. 7-9 include two chargers, the basic principles could be extended to chargers including more than two modules. Additionally, the charging, discharging, and heat generation modes of the chargers in FIGS. 7-9 may, but need not, employ the various operating modes described above. In some applications, the current differences used to provide the net charging current and heat generation may be generated using straightforward current control of the respective chargers without necessarily employing the various heat generating switching modes 1A, 1B, 1C, 2A, and 2B described above.

With reference to FIG. 7, a system 700 is illustrated in an AC source 705 is coupled to first and second chargers 707-1 and 707-2. More specifically, AC source 705 provides a first current 706-1 to first charger 707-1 and receives a second current 706-2 from second charger 706-2. (As described further below, these currents may be equal such that the net current delivered to/received from AC source 705 is zero.) Chargers 707-1 and 707-2 can each include respective AC sides 707-1a/707-2a and respective DC sides 707-1b/707-2b as described above. In the operating mode of FIG. 7 (Mode 3A), neither charger delivers charging current to battery 709, which can be decoupled from the chargers by opening contactors T1/T2. Rather, the “charging” current 708-1 delivered by charger 707-1 can be equal to the “discharging” current 708-2, which would result in a net zero current to battery 709, even if contactors T1/T2 were closed. In this example, “charging” current refers to current when charger 707-1 is operated in the forward or battery charging direction, and “discharging” current refers to current when charger 707-2 is operated in the reverse or battery discharging direction, even though no current is flowing to battery 709. Thus, in the illustrated example, heat can be generated by chargers 707-1 and 707-2 by virtue of current that is effectively being circulated through the chargers, and heating can be controlled by controlling the circulating power flow. As described above, this heating mode (3A) can be applied to any charger architecture that employs a modular charger with two or more modules.

FIG. 8 illustrates a system 800 in which an AC source 805 is coupled to first and second chargers 807-1 and 807-2. More specifically, AC source 805 provides a first current 806-1 to first charger 807-1 and receives a second current 806-2 from second charger 806-2, resulting in a net current draw 806 from AC source 805. Chargers 807-1 and 807-2 can each include respective AC sides 807-1a/807-2a and respective DC sides 807-1b/807-2b as described above. In the operating mode of FIG. 8 (Mode 3B), charger 807-1 delivers charging current 808-1 to battery 809, and charger 807-2 draws discharging current 808-2 from battery 809, resulting in a net charging current 808 being delivered to the battery (assuming that charging current Ic/808-1 is greater than discharging current Id/808-2). Thus, in the illustrated example, heat Hx can be generated by charger 807-1 and heat Hy can be generated by charger 807-2 by virtue of current that is effectively being circulated through the chargers, and heating can be controlled by controlling the circulating power flow. Additionally, the net current difference between the charging current Ic/808-1 and discharging current Id/808-2 controls the amount of charging current delivered to the battery. For example, if battery charging requires 10 A, the charging current Ic can be 10 A and the discharging current can be 0 A, resulting in little to no heat generation. Alternatively, the same net charging current could be provided by providing a charging current of 15 A and a discharging current of 5 A, providing a relatively lower amount of heat or by providing a charging current of 20 A and a discharging current of 10 A, providing a relatively higher amount of heat. These values are merely exemplary, and heat generation can be controlled thermostatically by providing some sort of temperature or other feedback to the current control loops. As described above, this heating mode (3B) can be applied to any charger architecture that employs a modular charger with two or more modules.

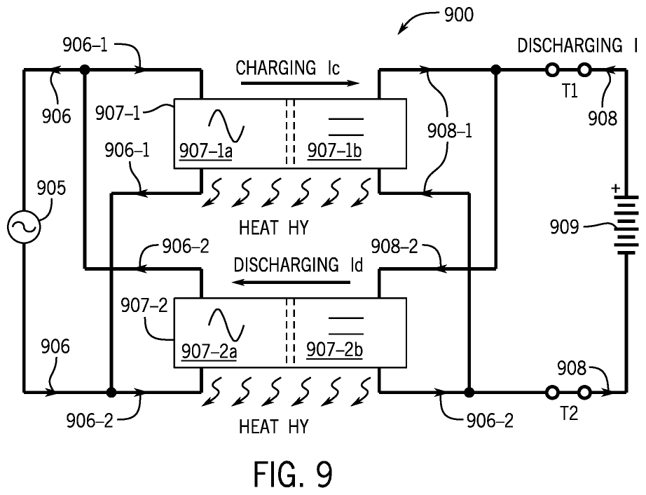

FIG. 9 illustrates a system 900 in which an AC source 905 is coupled to first and second chargers 907-1 and 907-2. More specifically, AC source 905 provides a first current 906-1 to first charger 907-1 and receives a second current 906-2 from second charger 906-2, resulting in a net current delivery 906 to AC source 905. Chargers 907-1 and 907-2 can each include respective AC sides 907-1a/907-2a and respective DC sides 907-1b/907-2b as described above. In the operating mode of FIG. 9 (Mode 3C), charger 907-1 delivers charging current 908-1 to battery 909, and charger 907-2 draws discharging current 908-2 from battery 909, resulting in a net discharging current 908 being drawn from the battery (assuming that charging current Ic/908-1 is less than discharging current Id/908-2). Thus, in the illustrated example, heat Hx can be generated by charger 907-1 and heat Hy can be generated by charger 907-2 by virtue of current that is effectively being circulated through the chargers, and heating can be controlled by controlling the circulating power flow. Additionally, the net current difference between the charging current Ic/908-1 and discharging current Id/908-2 controls the amount of discharging current drawn from the battery. For example, if the desired battery discharging current is 10 A, the charging current Ic can be 0 A and the discharging current can be 10 A, resulting in little to no heat generation. Alternatively, the same net discharging current could be provided by providing a charging current of 5 A and a discharging current of 15 A, providing a relatively lower amount of heat or by providing a charging current of 10 A and a discharging current of 20 A, providing a relatively higher amount of heat. These values are merely exemplary, and heat generation can be controlled thermostatically by providing some sort of temperature or other feedback to the current control loops. As described above, this heating mode (3C) can be applied to any charger architecture that employs a modular charger with two or more modules.

The foregoing describes exemplary embodiments of battery charging systems operable to provide auxiliary heating by controlling operation of the charger(s) and associated switching devices. Such configurations may be used in a variety of applications but may be particularly advantageous when used in conjunction with vehicular charging systems, grid storage battery systems, and the like. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A battery charger comprising:
an AC side stacked half bridge converter having an input adapted to be coupled to an AC source and an output comprising a first switch node of a first upper half bridge and a second switch node of a first lower half bridge coupled to a primary winding of a transformer;
a DC side stacked half bridge converter having an output selectively couplable to a battery by one or more contactors and an input comprising a third switch node of a second upper half bridge and a fourth switch node of a second lower half bridge coupled to a secondary winding of the transformer; and
control circuitry that receives one or more sensed inputs and generates drive signals for switching devices of the respective half bridges, wherein the control signals operate the battery charger in a heating mode that does not deliver charging current to or draw discharging current from the battery by:
closing one switch of the second upper half bridge and one switch of the second lower half bridge to provide a current path through the secondary winding of the transformer that does not include the battery; and
alternating between:
a first switching state in which a high side switch of the first upper half bridge and a low side switch of the first lower half bridge are closed and a low side switch of the first upper half bridge and a high side switch of the first lower half bridge are open; and
a second switching state in which the high side switch of the first upper half bridge and the low side switch of the first lower half bridge are open and the low side switch of the first upper half bridge and the high side switch of the first lower half bridge are closed.

2. The battery charger of claim 1 wherein closing one switch of the second upper half bridge and one switch of the second lower half bridge to provide a current path through the secondary winding of the transformer that does not include the battery comprises closing a low side switch of the second upper half bridge and a high side switch of the second lower half bridge.

3. The battery charger of claim 1 wherein closing one switch of the second upper half bridge and one switch of the second lower half bridge to provide a current path through the secondary winding of the transformer that does not include the battery comprises closing a low side switch of the second upper half bridge and a low side switch of the second lower half bridge.

4. The battery charger of claim 1 wherein closing one switch of the second upper half bridge and one switch of the second lower half bridge to provide a current path through the secondary winding of the transformer that does not include the battery comprises closing a high side switch of the second upper half bridge and a high side switch of the second lower half bridge.

5. The battery charger of claim 1 wherein closing one switch of the second upper half bridge and one switch of the second lower half bridge to provide a current path through the secondary winding of the transformer that does not include the battery comprises alternating between:
closing a low side switch of the second upper half bridge and a low side switch of the second lower half bridge; and
closing a high side switch of the second upper half bridge and a high side switch of the second lower half bridge.

6. The battery charger of claim 1 wherein the control circuitry regulates a frequency of switching between the first switching state and the second switching state to control heat generated by the heating mode.

7. The battery charger of claim 1 wherein at least one of the sensed inputs is a temperature sensor and the control circuitry regulates the frequency of switching between the first switching state and the second switching state responsive to the temperature sensor.

8. The battery charger of claim 1 wherein closing one switch of the second upper half bridge and one switch of the second lower half bridge to provide a current path through the secondary winding of the transformer that does not include the battery and alternating between the first and second switching state occur during off intervals of a burst mode charging operation.

9. A battery charger comprising:
an AC side stacked half bridge converter having an input adapted to be coupled to an AC source and an output comprising a first switch node of a first upper half bridge and a second switch node of a first lower half bridge coupled to a primary winding of a transformer;
a DC side stacked half bridge converter having an output selectively couplable to a battery by one or more contactors and an input comprising a third switch node of a second upper half bridge and a fourth switch node of a second lower half bridge coupled to a secondary winding of the transformer; and
control circuitry that receives one or more sensed inputs and generates drive signals for switching devices of the respective half bridges, wherein the control signals operate the battery charger in a heating mode that does not deliver current to or draw current from the AC source by:
closing a lower switch of the first upper half bridge and an upper switch of the first lower half bridge to provide a current path through the primary winding of the transformer that does not include the AC source; and
alternating between first and second switching states of the second upper and second lower half bridges that selectively couple the battery to the secondary winding of the transformer.

10. The battery charger of claim 9 wherein:
in the first switching state, a high side switch of the second upper half bridge and a low side switch of the second lower half bridge are closed and a low side switch of the second upper half bridge and a high side switch of the second lower half bridge are open; and
in the second switching state, a high side switch of the second upper half bridge and a low side switch of the second lower half bridge are open and a low side switch of the second upper half bridge and a high side switch of the second lower half bridge are closed.

11. The battery charger of claim 9 wherein:
in the first switching state, a low side switch of the second upper half bridge and a low side switch of the second lower half bridge are closed and a high side switch of the second upper half bridge and a high side switch of the second lower half bridge are open; and
in the second switching state, a high side switch of the second upper half bridge and a high side switch of the second lower half bridge are closed and a low side switch of the second upper half bridge and a low side switch of the second lower half bridge are open.

12. The battery charger of claim 9 wherein the control circuitry regulates a frequency of switching between the first switching state and the second switching state to control heat generated by the heating mode.

13. The battery charger of claim 12 wherein at least one of the sensed inputs is a temperature sensor and the control circuitry regulates the frequency of switching between the first switching state and the second switching state responsive to the temperature sensor.

14. The battery charger of claim 9 wherein the control circuitry regulates a duty cycle of switching between the first switching state and the second switching state to control heat generated by the heating mode.

15. The battery charger of claim 14 wherein at least one of the sensed inputs is a temperature sensor and the control circuitry regulates the duty cycle of switching between the first switching state and the second switching state responsive to the temperature sensor.

16. The battery charger of claim 9 wherein the control circuitry regulates a frequency and duty cycle of switching between the first switching state and the second switching state to control heat generated by the heating mode.

17. The battery charger of claim 16 wherein at least one of the sensed inputs is a temperature sensor and the control circuitry regulates the frequency and duty cycle of switching between the first switching state and the second switching state responsive to the temperature sensor.

18. A method of operating a battery charger to provide heating, the battery charger having an AC side stacked half bridge configuration including first upper and lower half bridges coupled to a primary winding of a transformer and a DC side stacked half bridge configuration including second upper and lower half bridges coupled to a secondary winding of the transformer, the method comprising:
operating either the first upper and lower half bridges to provide a first current path through the primary winding that does not include an AC source or the second upper and lower half bridges to provide a second current path through the secondary winding that does not include a battery; and
if operating the first upper and lower half bridges to provide a first current path through the primary winding that does not include an AC source, operating the second upper and lower half bridges to alternate between first and second switching states that selectively couple a battery to the secondary winding of the transformer; or
if operating the second upper and lower half bridges to provide a second current path through the secondary winding that does not include the battery, operating the first upper and lower half bridges to alternate between first and second switching states that selectively couple the AC source to the primary winding of the transformer.

19. The method of claim 18 further comprising controlling a frequency of alternating between the first and second switching states to control heat generated.

20. The method of claim 19 further comprising controlling a duty cycle of the first and second switching states to control heat generated.
